(19) United States
(12) Patent Application Publication
(10) Pub. No.: US 2008/0240621 A1
(43) Pub. Date: Oct. 2, 2008

(54) IMAGE PROCESSING APPARATUS AND IMAGE PROCESSING METHOD

(75) Inventors: Masaaki Yasunaga, Shizuoka-ken (JP); Sunao Tabata, Shizuoka-ken (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/027,541

(22) Filed: Feb. 7, 2008

(30) Foreign Application Priority Data
Mar. 26, 2007 (JP) 2007-078363

(51) Int. Cl. G06K 9/20

(52) U.S. Cl. 382/317

(57) ABSTRACT

An image processing apparatus comprises an operation unit configured to set an input resolution, an image input unit configured to input image information at the input resolution, and an appropriate resolution determination unit configured to determine whether the input resolution is appropriate or not on the basis of the input image information inputted by the image input unit.

### CROSS-REFERENCE TO RELATED APPLICATION

This application is based upon and claims the benefit of priority from the prior Japanese Patent Application No. 2007-078363 filed on Mar. 26, 2007, the entire contents of which are incorporated herein by reference.

### BACKGROUND

1. Field of the Invention

The present invention relates to an image processing apparatus such as a scanner and an image processing method.

2. Description of the Related Art

With the progress of the digital technique, many documents are digitized. Among them, there are found many movements of scanning a document and processing it electronically. In this case, an art of performing an OCR process of converting a scanned document to text data instead of image data and providing easily usable electronic data to a user has been developed. Furthermore, an image processing technique which is usable and efficient for a user is desired. For efficient image input, as described in Japanese Patent Application Publication No. 2002-354212, there is an example available of reading a document or an OCR sheet in which the first page includes an exclusive mark sheet or bar-code and on the basis of the character information included therein, deciding the reading mode of the second and subsequent pages.

However, when reading a document or an OCR sheet including the first page with an exclusive mark sheet or bar-code recorded, it is necessary to reflect the resolution or reading mode which is judged to be optimum by the user on the mark sheet or others. At this time, the user must decide an appropriate resolution, so that it is an operation not only difficult to judge but also requiring a great deal of time. Furthermore, when no appropriate input resolution is set, character collapse or distortion occurs in an input image and even if the OCR process is performed, a problem arises that correct characters cannot be extracted.

### SUMMARY

An object of the present invention is to provide an image processing apparatus and an image processing method for inputting an image at an appropriate resolution.

According to the embodiments of the present invention, there is provided an image processing apparatus comprising an operation unit configured to set an input resolution; an image input unit configured to input image information at the input resolution; and an appropriate resolution determination unit configured to determine whether the input resolution is appropriate or not on the basis of the input image information inputted by the image input unit.

According to the embodiments of the present invention, there is provided an image processing method comprising receiving an input resolution set by an operation unit; inputting image information at the input resolution received; and determining whether the input resolution is appropriate or not on the basis of the input image information inputted.

### BRIEF DESCRIPTION OF THE DRAWINGS

FIG. 1 is a block diagram of the image processing apparatus relating to Embodiment 1 of the present invention;

FIG. 2 is a detailed diagram of the appropriate resolution determination unit of the image forming apparatus relating to Embodiment 1 of the present invention;

FIG. 3 is a flow chart showing the constitution and operation of the appropriate resolution determination unit of the image processing apparatus relating to Embodiment 2 of the present invention;

FIG. 4 is a flow chart showing the constitution and operation of the image processing apparatus relating to Embodiment 3 of the present invention;

FIG. 5 is a block diagram of the image processor relating to Embodiment 4 of the present invention; and

FIG. 6 is a flow chart showing the operation of the image processor relating to Embodiment 4 of the present invention.

### DETAILED DESCRIPTION OF THE EMBODIMENTS

Hereinafter, the preferred embodiments for executing the embodiments of the present invention will be explained with reference to the accompanying drawings.

### Embodiment 1

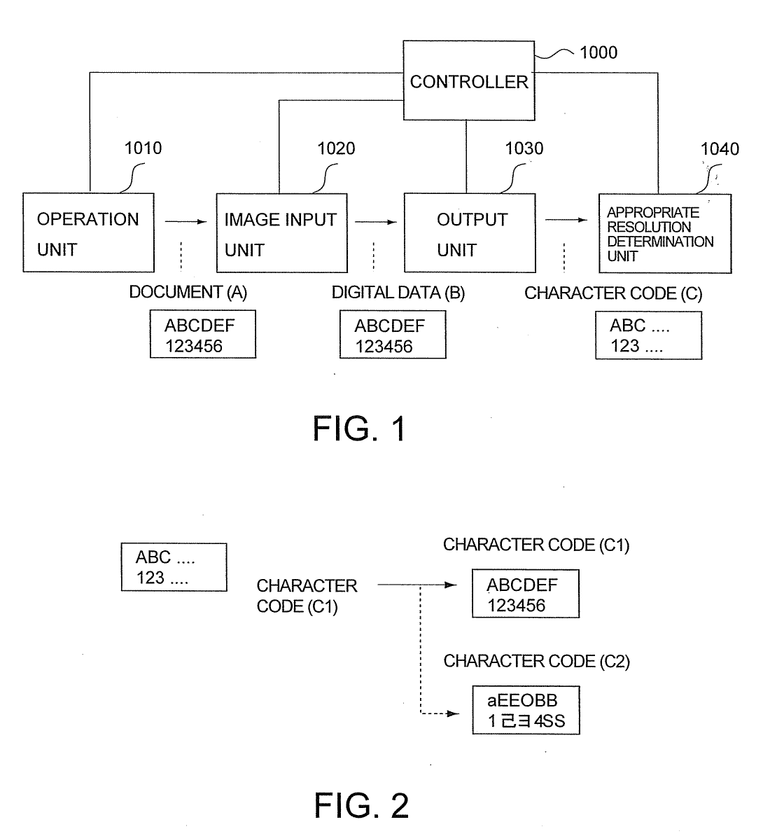

FIG. 1 is a block diagram of the image processing apparatus relating to Embodiment 1 of the present invention. The image processing apparatus relating to this embodiment is composed of an image input unit 1020 for inputting a document, an output unit 1030 for outputting a character code on the basis of information inputted to the image input unit 1020, an appropriate resolution determination unit 1040, an operation unit 1010 for displaying various operations such as setting of the resolution at time of image input or an alarm, and a controller 1000 for controlling the entire image processing apparatus.

As the image input unit 1020, for example, there is a scanner available, which inputs a document (A) such as a paper document or a digital image and outputs digital data (B) at a designated resolution. Further, the scanner receives input on the basis of an instruction from an external connected device such as a personal computer (PC) and can output the digital data (B) at the designated resolution.

Then, the output unit 1030, on the basis of the digital data (B), outputs a character code (C). The appropriate resolution determination unit 1040, from the information of the character code (C), decides whether the resolution set at time of input is appropriate or not.

FIG. 2 shows a conversion example of the character code relating to Embodiment 1 of the present invention. The character code (C) converted at the output unit 1030 is inputted to the appropriate resolution determination unit 1040. Here, the character code (C), when it is converted appropriately from the document, expresses a character code “(C1)” and when it is not converted appropriately from the document, expresses a character code “(C2)”.

The appropriate resolution determination unit 1040, for the character code (C1) or (C2), decides the resolution on the basis of whether the character can be recognized appropriately or not. For example, as the character code (C1) shown in FIG. 2, when significant character strings or regular character strings are arranged side by side, it is decided that the characters can be recognized appropriately and it is regarded that image input is carried out without trouble at the present input resolution.

Further, for example, as the character code (C2) shown in FIG. 2, when significant character strings or regular character strings are not arranged side by side, it is decided that the characters cannot be recognized and it is regarded that there is a problem imposed in the present input resolution.

The character code (C1) or (C2) is displayed on the operation unit (for example, a control panel) 1010, and an operator looks at it and judges whether image input is carried out at an appropriate resolution or not, and either can be selected by the operation unit. When he judges that image input is carried out at the appropriate resolution, he selects Yes by the operation unit, thus image input is carried out at the present resolution.

Further, when he judges that image input is not carried out at the appropriate resolution, he selects No by the operation unit, then resets again the resolution of image input, thereby permits the operation unit to carry out again image input.

### Embodiment 2

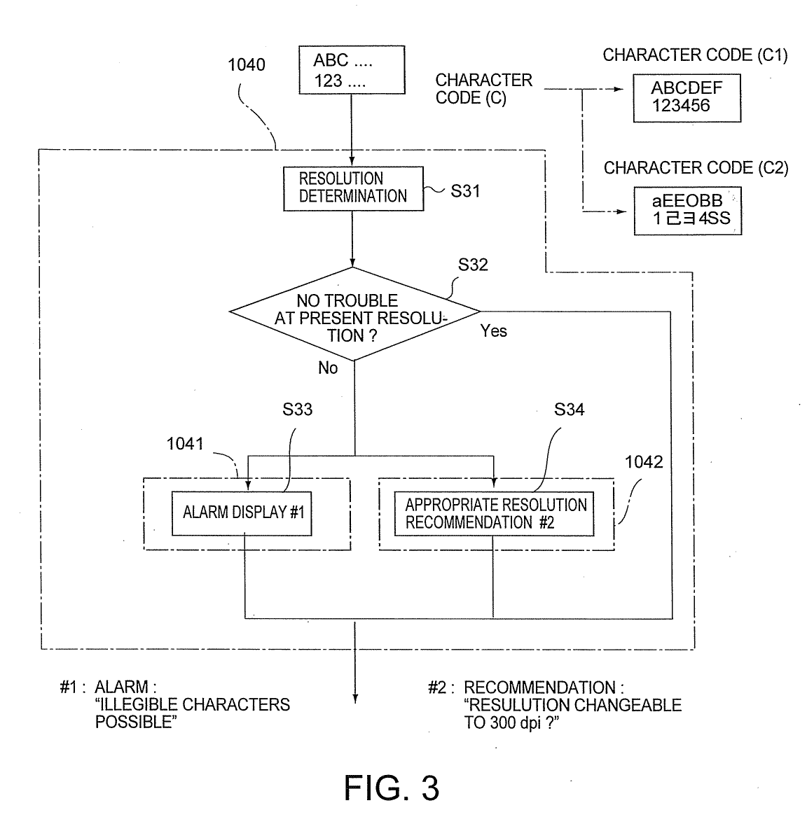

Then, the second embodiment of the present invention will be explained by referring to FIG. 3. Further, to the same parts as those shown in Embodiment 1 of the present invention, the same numerals are assigned and the explanation will be omitted. (The same may be said with the subsequent embodiments.)

FIG. 3 shows the constitution and flow chart of the appropriate resolution determination unit 1040 of the image processing apparatus relating to Embodiment 1 of the present invention. The character code (C) converted by the output unit 1030 is inputted to the appropriate resolution determination unit 1040. Here, the character code (C), when it is converted appropriately from the document, expresses the character code “(C1)” and when it is not converted appropriately from the document, expresses the character code “(C2)”.

The appropriate resolution determination unit 1040, for the character code (C1) or (C2), decides the resolution on the basis of whether the character can be recognized appropriately or not. For example, as the character code (C1) shown in FIG. 2, when significant character strings or regular character strings are arranged side by side (Yes at Step S32), it is decided that the characters can be recognized appropriately and it is regarded that image input is carried out without trouble at the present input resolution.

Further, for example, as the character code (C2) shown in FIG.2, when significant character strings or regular character strings are not arranged side by side (No at Step S32), it is decided that the characters cannot be recognized, and it is regarded that there is a problem imposed in the present input resolution, and the decision therefor is made by the controller on the basis of the existing method using the OCR.

When it is regarded that there is a problem imposed in the present input resolution (No at Step S32), on an alarm display 1041, an alarm such as “illegible characters possible” as shown in #1 in FIG. 3 is displayed (Step S33). Or, by an appropriate resolution recommendation unit 1042, a proposal such as “resolution changeable to 300 dpi?” as shown in #2 in FIG. 3 is made (Step S34). Furthermore, proposals of display of alarm and appropriate resolution may be made simultaneously.

Here, the display of alarm aforementioned may be carried out on the operation unit of the image processing apparatus or on a personal computer not drawn which is connected to the image processing apparatus and a network. Similarly, the disposal of appropriate resolution may be carried out on the operation unit of the image processing apparatus or on a personal computer not drawn which is connected to the image processing apparatus and the network. The operator looks at the proposals of alarm and appropriate resolution, decides the resolution of image input, thereby can execute again image input.

### Embodiment 3

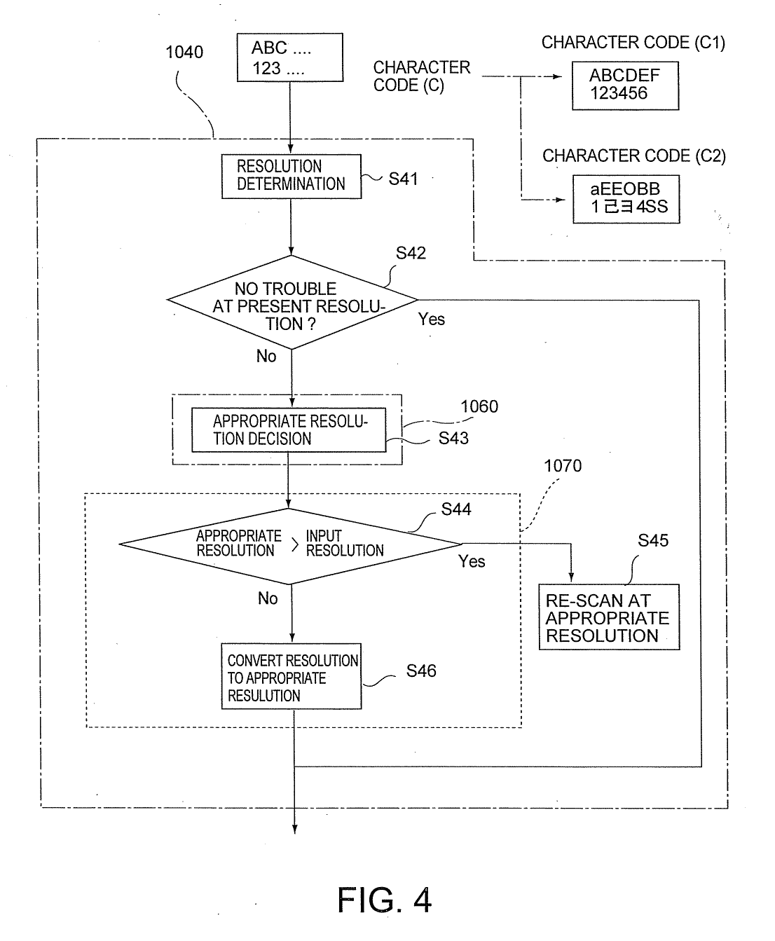

Then, Embodiment 3 of the present invention will be explained by referring to FIG. 4. FIG. 4 shows the constitution and flow chart of the appropriate resolution determination unit 1040 of the image processing apparatus relating to Embodiment 3 of the present invention. As a result of resolution determination (S41) by the appropriate resolution determination unit 1040, when it is regarded that the present input resolution is questionable (No at Step S42), the appropriate resolution decided by an appropriate resolution decision unit 1060 for deciding an appropriate input resolution (S43) and the input resolution are compared with each other (S44). When the appropriate resolution is higher than the input resolution (Yes at Step S44), since the resolution at time of input is low, the input image information is insufficient, thus it may be considered that an appropriate OCR process is not performed, so that image input is carried again at an appropriate resolution (S45). In this case, as an image input unit, when an ADF is used, by a method for restarting the ADF automatically, image input may be automatically carried out again. Or, when inputting a document loaded on the platen glass, it is detected whether the platen glass cover is opened or not and when the platen glass cover is not opened, image input can be automatically carried out again.

Further, when image input is not automatically carried out again, a method for informing the user of execution of image input again at an appropriate resolution may be used. Further, when it is regarded that the present input resolution is questionable and the appropriate resolution is lower than the input resolution (No at Step S44), an image processor 1070 converts the digital data to an appropriate resolution and performs a process of lowering the resolution (S46). The reason is that at time of image input, even if the input resolution is higher, it is not always better and for example, if an input resolution higher than necessary is selected, the character recognition rate after the OCR process may be reduced rather.

### Embodiment 4

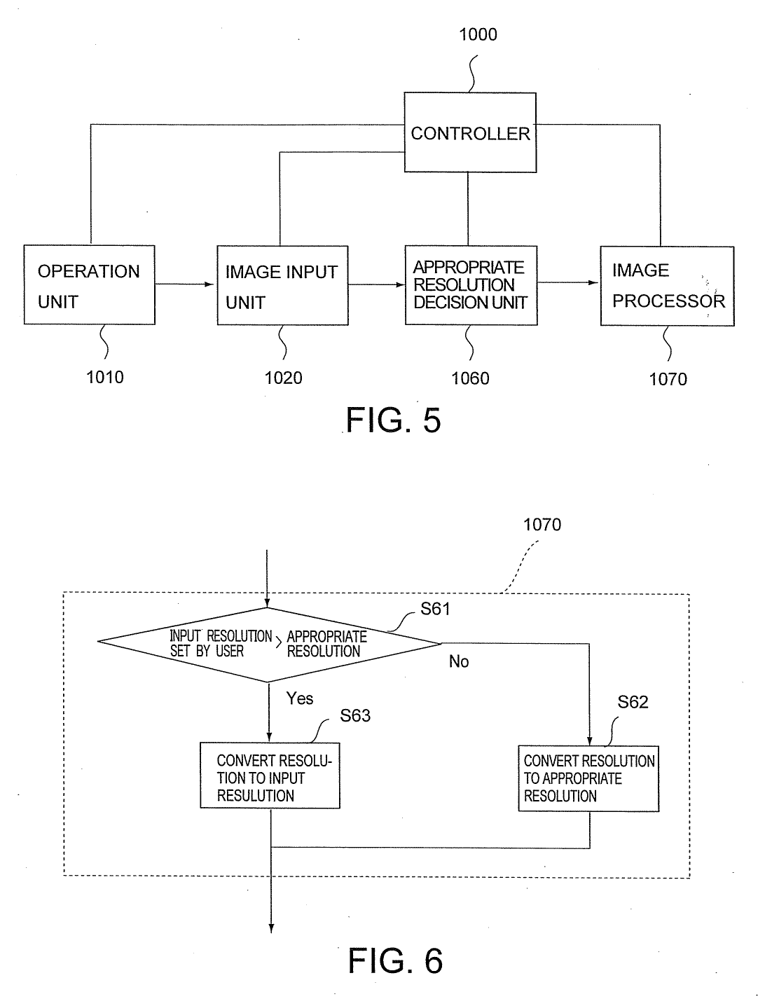

Then, Embodiment 4 of the present invention will be explained by referring to FIGS. 5 and 6. FIG. 5 is a block diagram of the image processor relating to Embodiment 4 of the present invention. The image processing apparatus is composed of the operation unit 1010 for setting an optional resolution, the image input unit 1020 for inputting an image, a controller not drawn having a function for inputting an image to the image input unit 1020 at a resolution higher than the set resolution set by the operation unit 1010, the appropriate resonance decision unit 1060, and the image processor 1070 for performing the image process for converting the digital data to the appropriate resolution.

FIG. 6 is a flow chart showing the operation of the image processor relating to Embodiment 4 of the present invention. Conventionally, the image input unit inputs an image at the resolution set by the operation unit 1010, though the input resolution set by the user is not always an appropriate resolution. Therefore, even if an image is inputted, it may not be recognized as correct characters and a correct image. Therefore, the input resolution may be changed again and an image may be re-input.

However, in this embodiment, an instruction is outputted from the controller 1000 to the image input unit 1020 so as to carry out image input using the input resolution higher than the set resolution and image input is carried out at the input resolution higher than the appropriate resolution deiced by the appropriate resolution decision unit 1060. When the aforementioned image input is carried out, the input resolution is higher than the appropriate resolution, so that thereafter, by the processing of the image processor 1070, digital data at an appropriate resolution can be obtained. Therefore, there is no need to carry out image input again and the user can obtain efficiently an image at an appropriate resolution.

Further, the image processor 1070 can have a function, when the input resolution set by the user is lower than the appropriate resolution (No at Step S61), for converting the digital data to an appropriate resolution (S62) and when the input resolution set by the user is higher than the appropriate resolution (Yes at Step S61), for converting the resolution of the digital data to an input resolution (S63). The reason is that digital data at a high resolution required by the user can be obtained.

What is claimed is:

1. An image processing apparatus comprising:
an operation unit configured to set an input resolution;
an image input unit configured to input image information at the input resolution; and
an appropriate resolution determination unit configured to determine whether the input resolution is appropriate or not on the basis of the input image information inputted by the image input unit.

2. The apparatus according to claim 1 further comprising:
an alarm display configured to inform that the input resolution is not appropriate when the appropriate resolution determination unit determines that the input resolution is not appropriate.

3. The apparatus according to claim 1 further comprising:
an appropriate resolution recommendation unit configured to recommend an appropriate resolution when the appropriate resolution determination unit determines that the input resolution is not appropriate.

4. An image processing apparatus comprising.
an operation unit configured to set an input resolution;
an image input unit configured to input image information at the input resolution;
an output unit configured to output a character code on the basis of the input image information inputted by the image input unit; and
an appropriate resolution determination unit configured to determine whether the input resolution is appropriate or not on the basis of the character code.

5. The apparatus according to claim 4 further comprising:
an alarm display configured to inform that the input resonance is not appropriate when the appropriate resolution determination unit determines that the input resolution is not appropriate.

6. The apparatus according to claim 4 further comprising:
an appropriate resolution recommendation unit configured to recommend an appropriate resolution when the appropriate resolution determination unit determines that the input resolution is not appropriate.

7. The apparatus according to claim 1 further comprising:
an appropriate resolution decision unit configured to decide an appropriate resolution of the input image information on the basis of digital data generated from the input image information; and
an image processor configured to perform a process of converting the resolution of the digital data to the appropriate resolution when the appropriate resolution determination unit determines that the input resolution is not appropriate and the appropriate resolution is lower than the input resolution.

8. The apparatus according to claim 1, wherein the image input unit inputs an image again at the appropriate resolution when the appropriate resolution determination unit determines that the input resolution is not appropriate and the appropriate resolution is higher than the input resolution.

9. The apparatus according to claim 7 further comprising:
a controller configured to control so as to input an image to the image input unit at a resolution higher than the set resolution set by the operation unit.

10. The apparatus according to claim 9, wherein the image processor further includes a function configured to convert the resolution of the digital data to the input resolution when the input resolution is higher than the appropriate resolution.

11. An image processing method comprising:
receiving an input resolution set by an operation unit;
inputting image information at the input resolution received; and
determining whether the input resolution is appropriate or not on the basis of the input image information inputted.

12. The method according to claim 11 further comprising:
informing that the input resolution is not appropriate when it is determined that the input resolution is not appropriate.

13. The method according to claim 11 further comprising:
recommending an appropriate resolution when it is determined that the input resolution is not appropriate.

14. An image processing method comprising:
receiving an input resolution set by an operation unit;
inputting image information at the input resolution received;
outputting a character code on the basis of the input image information inputted; and
determining whether the input resolution is appropriate or not on the basis of the outputted character code.

15. The method according to claim 14 further comprising:
informing that the input resolution is not appropriate when it is determined that the input resolution is not appropriate.

16. The method according to claim 14 further comprising:
recommending an appropriate resolution when it is determined that the input resolution is not appropriate.

17. The method according to claim 11 further comprising:
deciding an appropriate resolution of the input image information on the basis of digital data generated from the input image information; and
performing a process of converting the resolution of the digital data to the appropriate resolution when the input resolution is determined as not appropriate and the appropriate resolution is lower than the input resolution.

18. The method according to claim 11, wherein an image is inputted again at the appropriate resolution when the input resolution is determined as not appropriate and the appropriate resolution is higher than the input resolution.

19. The method according to claim 17 further comprising:
inputting an image at a higher resolution than the set resolution set by the operation unit.

20. The method according to claim 19, wherein the resolution of the digital data is converted further to the input resolution when the input resolution is higher than the appropriate resolution.
